(19) United States
(12) Patent Application Publication
(10) Pub. No.: US 2002/0086702 A1
(43) Pub. Date: Jul. 4, 2002

(54) Personal digital assistant with a multi-functional flip cover

(76) Inventors: Cheng-Shing Lai, Taipei (TW); Jie Yuan, Nanching (CN)

Correspondence Address: BIRCH STEWART KOLASCH & BIRCH, PO BOX 747, FALLS CHURCH, VA, 22040-0747, US

(21) Appl. No.: 09/749,391

(22) Filed: Dec. 28, 2000

(51) Int. Cl. H04M 1/00

(52) U.S. Cl. 455/556; 455/566

(57) ABSTRACT

A personal digital assistant (PDA) with a multi-functional flip cover, which integrates the mobile phone function onto the flip cover so that the flip cover becomes the dial panel of the mobile phone when it is closed. The user can make and receive phone calls and read messages displayed on the screen. When it is open, the user can enjoy the PDA functions. The invention thus makes the mobile phone function of the PDA much convenient in use.

### BACKGROUND OF THE INVENTION

1. Field of Invention

The present invention relates to a personal digital assistant with the function of a mobile phone and, more particularly, to a personal digital assistant integrates the mobile phone function onto a flip cover.

2. Related Art

The personal digital assistant (PDA) is a small computer of a palm size. It contains such functions as simple document processing, statistical calculations, numerical computations, databases, and making spreadsheets. Although its speed is not as fast as laptop computers, it includes common functions for personal uses. Most of them even allow wireless or wired data transmission to exchange data with usual personal computers (PCs).

Since normally a PDA is of the palm size, its volume is much smaller than a laptop computer. Therefore, the display of the PDA is directly embedded on the host. In order for the user to read information from the PDA, the display occupies a substantial portion of the host. Due to the limitation of the host volume, only a few input keys can be installed on the host. These keys are obviously inadequate for practical purposes; therefore the display of the PDA is usually a touch-control display so that the user can use a touch-control pen to give commands through the display. Nevertheless, the keys and touch-control display are often still insufficient. In addition, since the PDA display is flatly installed on the host, a flip cover is usually provided to protect the display so that the display is shielded by the flip cover when not in use.

Most modern PDAs also integrate the mobile phone functions. The user uses the touch-control pen to click the number symbols on the screen to dial numbers. In this case, the flip cover still only has the function of protecting the display. When the user wants to use the mobile phone function, he has to open the flip cover first. This is obviously very inconvenient and against to people's convention of making phone calls by pressing number buttons.

Some inventions in the prior art put the number buttons on the flip cover and use the button to click the touch-control display. However, this method does not allow the user to see the message shown on the screen. Thus, it is still very inconvenient.

### SUMMARY OF THE INVENTION

It is a primary object of the invention to provide a personal digital assistant (PDA) with a multi-functional flip cover so that the user can use the mobile phone function of the PDA without opening the flip cover.

The disclosed invention of a PDA with a multi-functional flip cover combines the functions of a mobile phone on the flip cover of the PDA. When the flip cover is closed, it becomes the dial panel of the mobile phone. The user can use such function to dial and receive phone calls and, at the same time, is able to read the message displayed on the PDA screen. The use can still use the PDA functions by opening the flip cover. The invention makes the mobile phone function of a PDA more convenient.

### BRIEF DESCRIPTION OF THE DRAWINGS

The present invention will become more fully understood from the detailed description given hereinbelow illustration only, and thus are not limitative of the present invention, and wherein:

FIG. 1 is a schematic view of the present invention;

FIG. 2 is a partial cross-sectional view of the invention;

FIG. 3 is a second embodiment of the sound holes of the invention;

FIG. 4 is a first embodiment of the fixture device of the invention; and

FIG. 5 is a second embodiment of the fixture device of the invention.

### DETAILED DESCRIPTION OF THE INVENTION

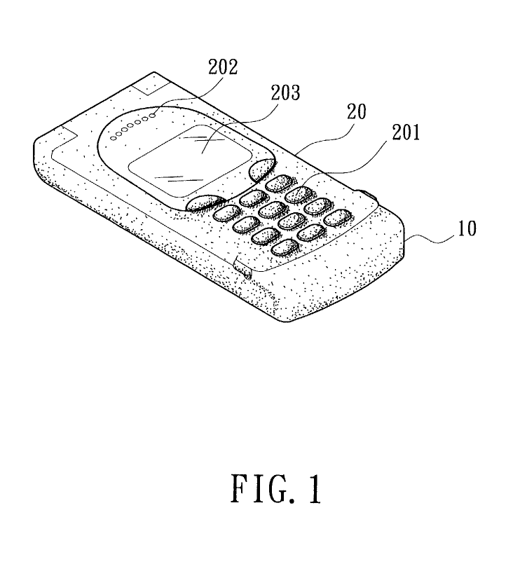

The personal digital assistant (PDA) with a multi-functional flip cover disclosed by the invention has the functions of both a PDA and a mobile phone. As shown in FIG. 1, the PDA contains a host 10 and a flip cover 20. The host 10 has the functions of both a PDA and a mobile phone. It also contains a display 101, which can be a touch-control screen so that the user can use a specific touch-control pen to click on the screen. The flip cover 20 is pivotally installed on the host 10 so that by rotating about the pivot, the flip cover 20 can be opened or closed. When it is closed, it can protect the display 101.

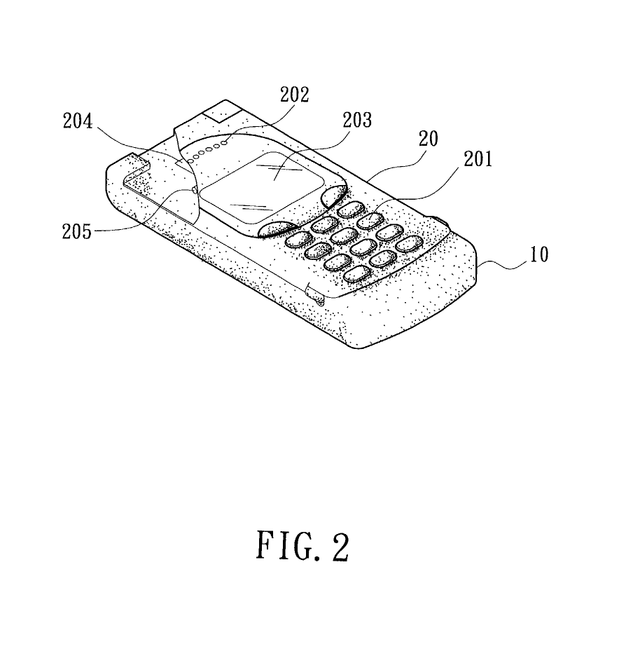

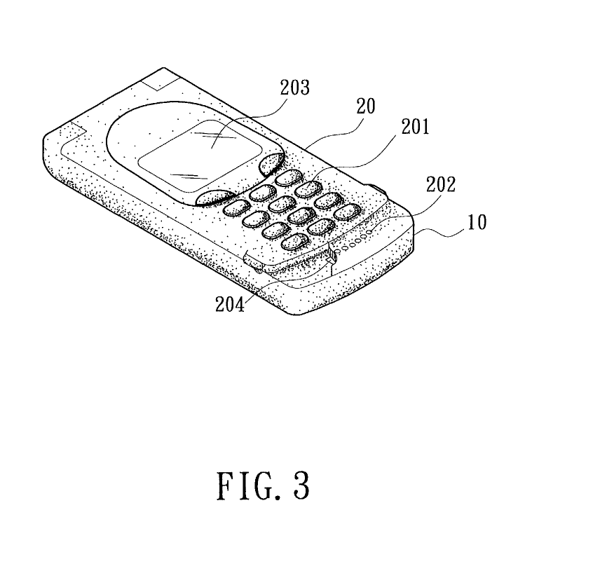

The flip cover 20 contains a plurality of buttons 201, a transparent window 203, and a few sound holes 202. The buttons 201 are provided for dialing numbers. They are connected to the host 10 through a circuit board so that the user can directly dial phone numbers on the flip cover 20. Since the flip cover 20 is limited in space, therefore, it often uses a flexible circuit board 205 to form electrical communications with the circuit in the host 10 (FIG. 2). The flexible circuit board 205 is a flat piece of flexible element. It can be curled or bent into an S shape for storage. Under the sound hole 202, a receiver/transmitter 204 is provided. The transparent window 203 is made of a transparent material, such as acryl or glass, for the user to view the message shown on the display 101 when using the mobile phone function. Furthermore, as shown in FIG. 3, the sound hole 202 and receiver/transmitter 204 can be installed on the host to achieve the same functions.

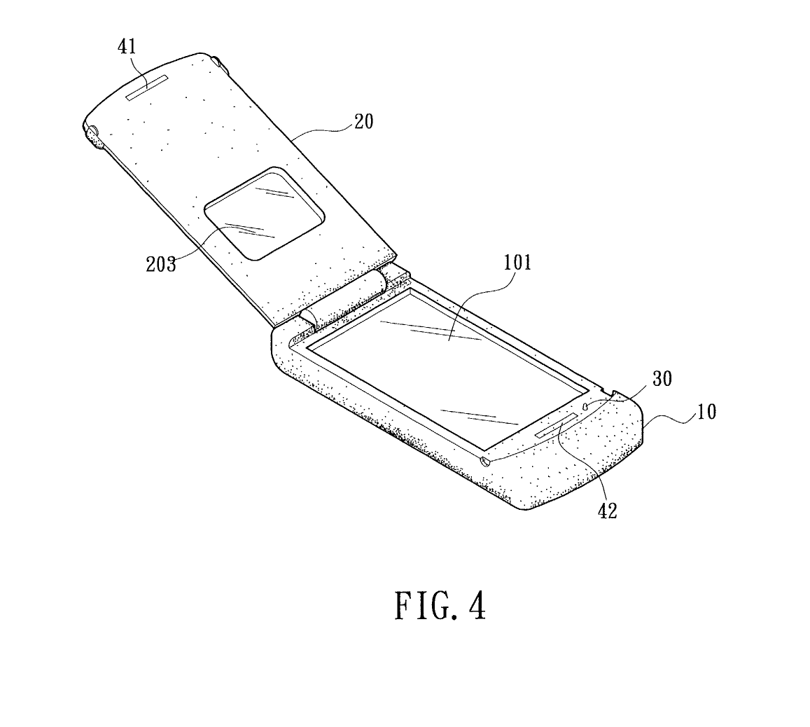

As shown in FIG. 1, the user can use the mobile phone function and dial phone numbers using the buttons 201 on the flip cover 20 when it is closed. With the receiver/transmitter 204 under the sound holes 202, the user can make or receive phone calls. Through the transparent window 203, the user can see the mobile phone status shown on the display 101, just like the usual mobile phones. When the flip cover is opened, as in FIG. 4, the user can use the PDA functions.

On the other hand, the host 10 further contains an electronic switch 30 (FIG. 4). When the flip cover 20 is closed, it will trigger the electronic switch 30, the display 101 will change to the mobile phone status interface (FIG. 1) and will fit into the size of the transparent window 203. When the flip cover 20 is opened, the display 101 will change to the PDA status interface for normal PDA uses.

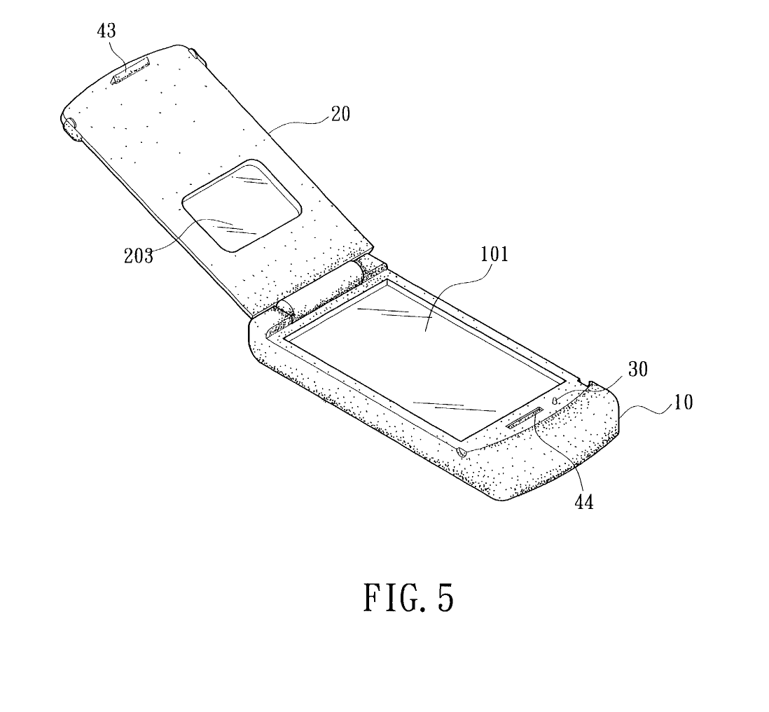

When the flip cover 20 is closed, a fixture device is provided to fix the flip cover at its position, as shown in FIG. 4. This fixture device can be implemented using a magnet 41 on the flip cover and a metal chip 42 on the host so that the flip cover 20 is stuck onto the host while being closed. Furthermore, as shown in FIG. 5, the fixture device can be a hook 43 installed on the flip cover and a hole on the host 10 in a second embodiment of the invention.

Effects of the Invention

The present invention integrates the mobile function on the flip cover pivotally installed on a PDA so that the mobile phone function of the PDA can be more convenient in use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A personal digital assistant (PDA) with a multi-functional flip cover, which comprises:
a host, which provides the functions of a PDA and a mobile phone and displays the operational interface of the mobile phone within a specific area of a screen; and
a flip cover with one side pivotally installed on the host comprising:
a set of buttons;
a transparent window provided at the corresponding position of the specific area so that the user can read the operational interface of the host screen; and
a circuit board electrically connecting to the host so that the user can us the mobile phone function.

2. The PDA of claim 1 further comprising a plurality of sound holes and a receiver/transmitter installed inside the plurality of sound holes.

3. The PDA of claim 2, wherein the sound holes and the receiver/transmitter is installed on the flip cover.

4. The PDA of claim 2, wherein the sound holes and the receiver/transmitter is installed on the host.

5. The PDA of claim 1 further comprising an electronic switch installed on the host so that the electronic switch will be triggered when the flip cover is closed so that the specific area of the host screen shows the operational interface of the mobile phone and, on the other hand, the electronic switch will be triggered when the flip cover is opened so that the host screen changes to the operational interface of the PDA.

6. The PDA of claim 1, wherein the transparent window is made of acryl.

7. The PDA of claim 1, wherein the transparent window is made of glass.

8. The PDA of claim 1, wherein the circuit board is a flexible circuit board.

9. The PDA of claim 1 further comprising a fixture device so as to keep the flip cover in the closed status.

10. The PDA of claim 9, wherein the fixture device is a magnet installed on the flip cover and a magnetic metal chip that can fix the flip cover at the closed position.

11. The PDA of claim 9, wherein the fixture device comprises:
a hook installed on the flip cover; and
a hole provided on the host that can hold the hook to fix the flip cover closed.

12. A PDA with a multi-functional flip cover comprised of a host and a flip cover, wherein the flip cover comprises:
a shell;
a circuit board installed in the shell to provide the mobile phone function;
a receiver/transmitter installed in the shell and electrically connecting to the circuit board;
a plurality of sound holes provided on one side of the shell that is on the outer side of the receiver/transmitter;
a plurality of buttons provided on one side of the shell, which is on the same side of the plurality of sound holes, providing the mobile phone function; and
a transparent window installed on the shell so that the user can see the PDA screen through the transparent window.

13. The flip cover of claim 12, wherein the circuit board is a flexible circuit board.

14. The flip cover of claim 12, wherein the transparent window is made of acryl.

15. The flip cover of claim 12, wherein the transparent window is made of glass.

16. The flip cover of claim 12 further comprising a magnet for keeping the flip cover closed.
